(19) United States
(12) Patent Application Publication
(10) Pub. No.: US 2003/0191939 A1
(43) Pub. Date: Oct. 9, 2003

(54) System and method for authentication in public networks

(75) Inventors: Hsien-Ming Tsai, Tainan (TW); Jammy Huang, Taipei (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: QUANTA COMPUTER INC.

(21) Appl. No.: 10/214,143

(22) Filed: Aug. 8, 2002

(30) Foreign Application Priority Data
Apr. 8, 2002 (TW) 91107000

(51) Int. Cl. H04L 9/00

(52) U.S. Cl. 713/168

(57) ABSTRACT

In conventional public networks, a subscriber identity module (SIM) is installed on a mobile station for authenticating users and improving the communication security between mobile stations and the network. This specification proposes an authentication agent (AA) installed on a network and with the SIM of the mobile station installed on the AA. Thus, the mobile station gets authenticated from the AA and then the AA uses the SIM of the mobile station to obtain authentication from the authentication server.

### BACKGROUND OF THE INVENTION

1. Field of Invention

The invention relates to a public network and, in particular, to an authentication system and method for public services on a wireless local area network (WLAN).

2. Related Art

Since the introduction of the global system for mobile communication (GSM), wireless communications have had a great breakthrough in security. This breakthrough came from the idea of installing a subscriber identity module (SIM) on the mobile phone, helping the mobile network in authentication and encryption. FIG. 1 shows a structure of the GSM authentication system in the prior art. The mobile phone 100 has an SIM card 88 for performing authentication with the GSM network. In the GSM network, the base station (BS) 36 exchanges wireless signals with the mobile phone 100 and wired signals with the mobile switch center (MSC) 70. The MSC 70 and the visitor location register (VLR) 75 have mission of performing an authentication procedure for the mobile phone 100. (Therefore, the MSC 70 and the VLR 75 are usually designed to be together.) Every time a mobile phone 100 requests services, the VLR 75 asks the MSC 70 to authenticate the mobile phone 100. The MSC 70 sends out an authentication request to and receives an authentication response from the mobile phone 100, checking whether the authentication response from the mobile phone 100 is correct. If the authentication is successful, the MSC 70 notifies the mobile 100 of services accept; otherwise, the MSC 70 notifies the mobile 100 of services reject. In other elements of the GSM network, the authentication center (AuC) 95 keeps authentication keys Ki of mobile phones 100, generates authentication parameters (e.g. RAND, SRES, and so on), and sends them to the VLR 75 through the home location register (HLR) 90. The billing center (BC) 80 accepts charging data records (CDR's) 86 generated by the MSC 70 for billing information.

In recent years, the WLAN has been used to provide public services due to its tremendous growth. When the public uses WLAN cards to access the Internet services through the public WLAN set up by a service provider, security becomes the most important issue. Therefore, most famous manufacturers install SIM cards in their WLAN card products to enhance the WLAN security. FIG. 2 shows a structure of the public WLAN authentication system in the prior art. The structure contains four types of elements: client end, access network end, Internet end, and GSM core network end. The user end includes a mobile station (MS) 10 and a WLAN card 200, where the WLAN card 200 is equipped with an SIM card 88. The access network end includes a WLAN access point (AP) 30, a router 40, and an authentication gateway (AG) 250. The Internet end contains the Internet 50 and a server 60. The GSM core network end includes a MSC 70, a VLR 75, an AuC 95, an HLR 90, and a BC 80 (just as in FIG. 1). In the structure shown in FIG. 2, if the MS 10 passes authentication, it then has access rights to the AP 30 and the router 40, connecting to the Internet 50 and obtaining the Internet services from the server 60. During the authentication process, when the MS 10 requires Internet services, it sends out a service request to the AG 250. The AG 250 transfers this service request to the VLR 75. The VLR 75 then asks the MSC 70 to send out an authentication request to the MS 10. This authentication request is transferred by the VLR 75 to the MS 10. The MS 10 uses the SIM card 88 of the WLAN card 200 to execute an authentication response. The authentication response is transferred by the AG 250 to the MSC 70, checking if the authentication is successful. If the authentication is successful, the MSC 70 notifies the AG 250 of services accept and the AG 250 allows the MS 10 to connect to the Internet 50 using the AP 30 and the router 40. If the authentication fails, the MSC 70 notifies the AG 250 of service reject. After the MS 10 passes the authentication, the router 40 generates a usage record. The AG 250 generates the charging data record according to such usage records and sends the charging data record to the BC 80. Therefore, the main task of the AG is to process the service request from the MS, to transfer the authentication signals between the MS and the MSC, to control the access right of the MS to the Internet, and to generate CDR's for the BC.

Due to the SIM card 88 embedded inside the WLAN card 200, the design of the WLAN card becomes much more complicated. Consequently, some companies choose to leave the current WLAN card design unchanged but add the SIM card function to the MS. As shown in FIG. 3, the MS 10 is equipped with a WLAN card 20. It reads the data on the SIM card 88 through a computer interface 300 (e.g. PCMCIA, USB, RS232, etc) to perform authentication. (The network end in FIG. 3 is totally the same as that in FIG. 2.)

From FIGS. 1 to 3, it is obvious that the SIM card 88 is embedded in the client end devices, such as the mobile phone 100 in FIG. 1, the WLAN card 200 in FIG. 2, and the laptop computer MS 10 in FIG. 3. In these authentication systems, the client end devices use the SIM card to obtain authentication from an authentication server. However, this requires design of an SIM card slot in the client end device, which unavoidably increases the complexity and cost in design.

### SUMMARY OF THE INVENTION

To avoid changes in the design of the client end devices, to lower the client end device cost, and to achieve the objective of public wireless network authentication, the invention provides an authentication system and method for public wireless networks. The system includes an MS, an authentication server, and an authentication agent (AA). The MS no longer has an SIM card installed. The SIM card of the MS is installed on the AA. So the MS performs authentication with the AA, while the AA perform authentication with the authentication server. In addition, the AA has to process the service request from the MS, control the access right of the MS to the Internet, and generate CDR's for the BC.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a structural diagram of the GSM authentication system in the prior art;

FIG. 2 is a structural diagram of the public WLAN authentication system in the prior art;

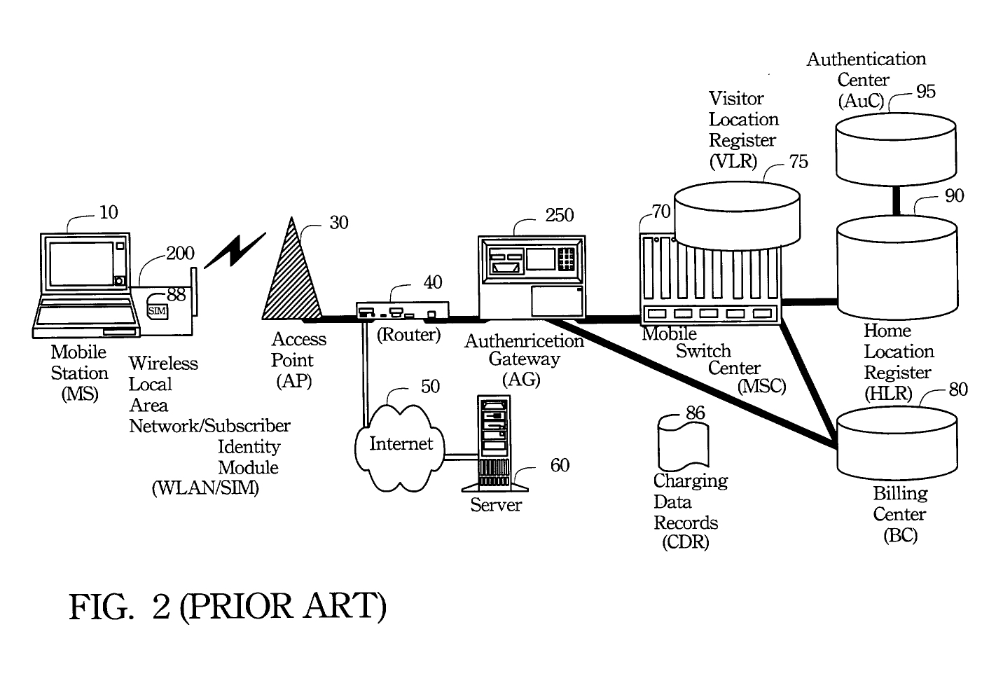

FIG. 3 is a structural diagram of the public WLAN authentication system in the prior art;

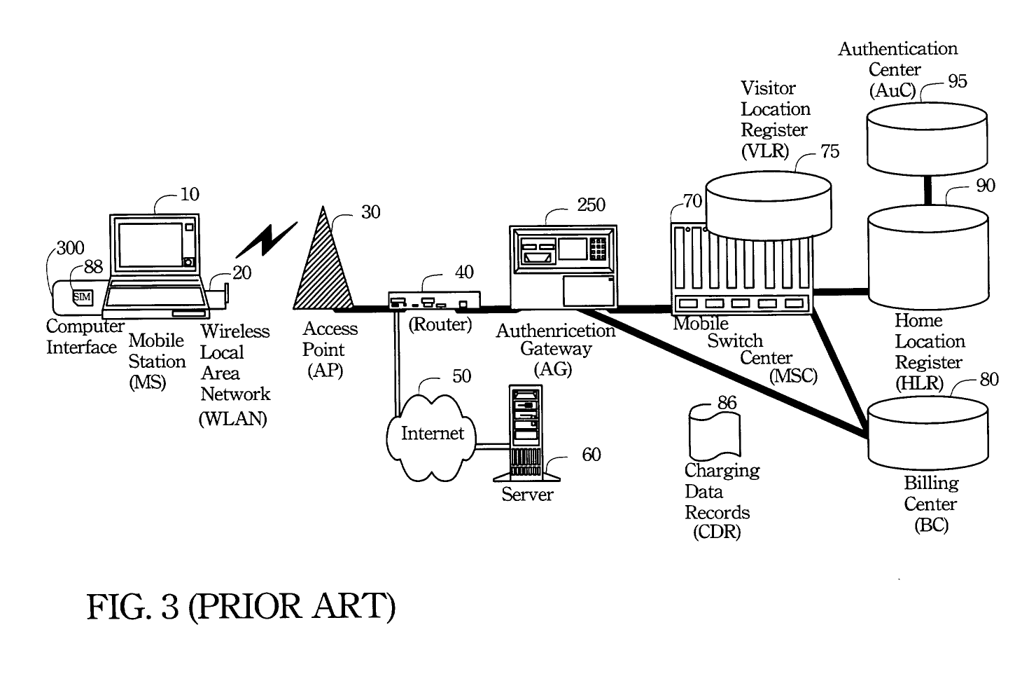

FIG. 4 is a structural diagram of the disclosed public WLAN authentication system according to the present invention;

FIG. 5 is a signaling flow chart of a normal MS in the authentication system according to the present invention; and

FIG. 6 is a signaling flow chart of a roaming MS in the authentication system according to the present invention.

### DETAILED DESCRIPTION OF THE PREFERRED EMBODIMENT

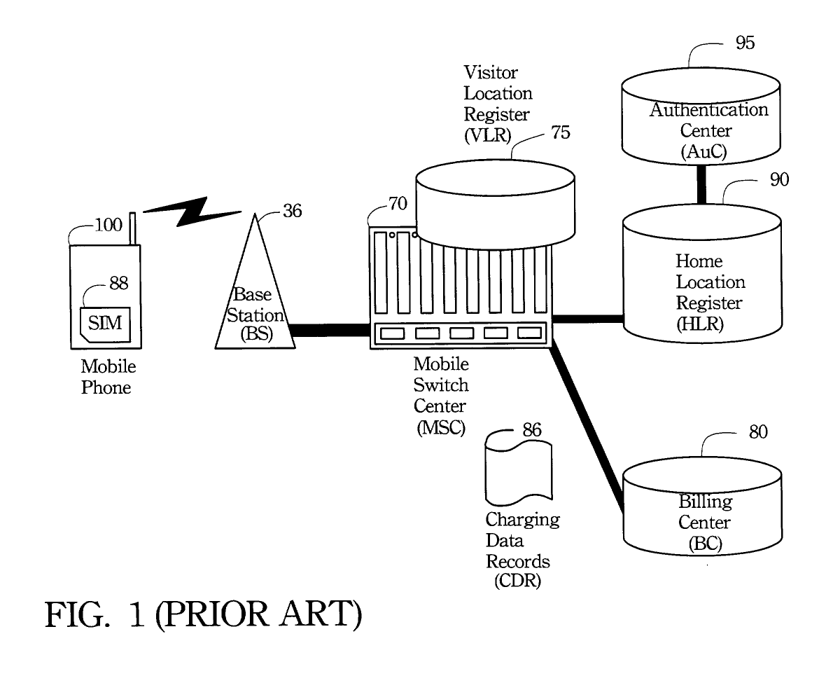

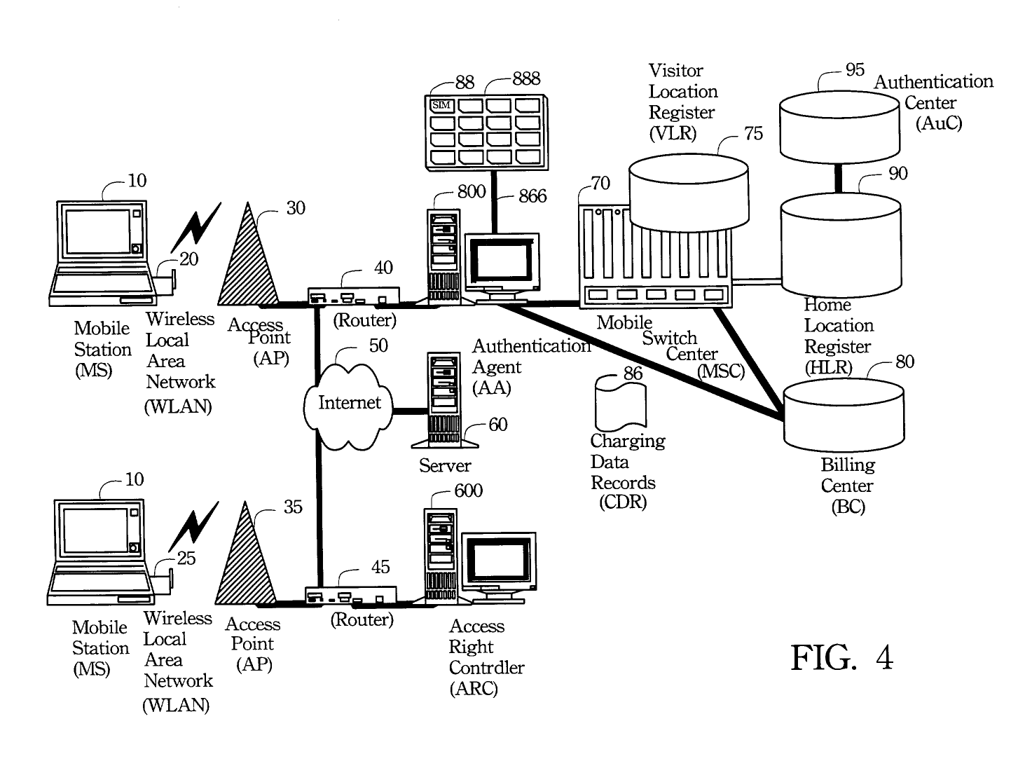

With reference to FIG. 4, the disclosed public WLAN authentication system comprises five types of elements: client end elements, access network end elements, external access network end elements, Internet end elements, and GSM core network end elements. The client end elements include an MS 10 and a WLAN card 20. The access network end elements include an AP 30, a router, and an AA 800 in a WLAN. The AA 800 is connected to an SIM card slot 888 through a computer interface 886. The SIM card slot 888 has an SIM card 88. The computer interface 886 may be an RS232, USB, PCI or PCMCIA bus so that the AA 800 can access the authentication information on the SIM card 88. The external access network end elements include a BS 35, a router 45, and an access right controller (ARC) 600. The Internet end elements include the Internet 50 and a server 60. The GSM core network end elements include an MSC 70, a VLR 75, an AuC 95, an HLR 90, and a BC 80. (The GSM core network end elements are the same as those in FIG. 1.)

In the structure of FIG. 4, when the MS 10 asks for the Internet services, the MS 10 has to authenticate with the AA 800 and the AA 800 authenticates with the MSC 70 using the SIM card 88 of the MS 10. The authentication communication protocol between the MS 10 and the AA 800 needs not be standard. It can be the remote authentication user service (RADIUS), Kerberos, or the service provider's property. If the MS 10 fails the authentication, the service request is rejected. If the MS 10 passes the authentication, it gains the access right to the BS 30 and the router 40 and is therefore able to obtain the Internet services from the server 60 and connect to the Internet 50. After the MS 10 obtains the Internet services, the router 40 generates a usage record. The AA 800 then produces CDR's according to such usage records for the BC 80.

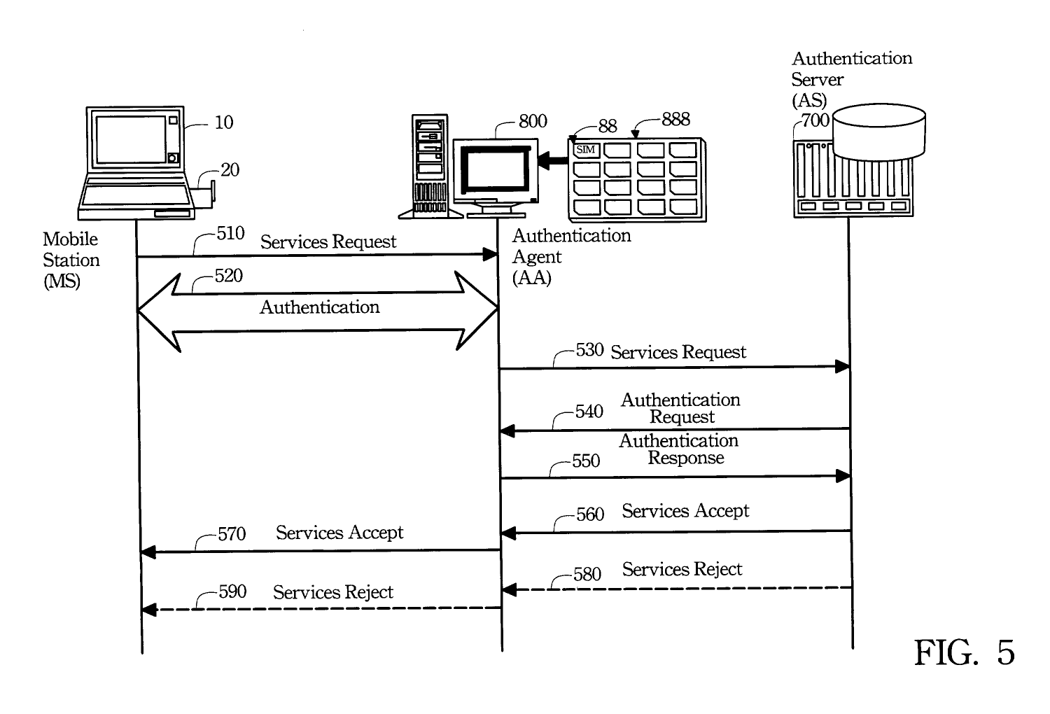

With reference to FIG. 5, the disclosed authentication system comprises three authentication elements: an MS 10, an AA 800, and an authentication server 700. The AA 800 has the SIM card 88 of the MS 10, to process authentication with the authentication server 700 on behalf of the MS 10. The authentication server 700 can be the MSC 70 in a GSM network, responsible for the authentication with the SIM card 88. When the MS 10 needs Internet services, it sends out a service request to the AA 800 (signal 510) and processes authentication with the AA 800 (signal 520). If the MS 10 fails the authentication, the service request is rejected. If the authentication is successful, the AA 800 sends out a service request to the authentication server 700 (signal 530). The authentication server 700 sends out an authentication request (signal 540) to the AA 800. The AA 800 uses the SIM card 88 of the MS 10 to process authentication response (signal 550). When the authentication server 700 receives the authentication response 550, it checks whether the authentication is successful. If the authentication is successful, the authentication server 700 notifies the AA 800 of the services accept (signal 560). The AA 800 then notifies the MS 10 of the services accept (signal 570). The AA 800 further allows the MS 10 to connect to the Internet. If the authentication fails, the authentication server 700 notifies the AA 800 of the services reject (signal 580). The AA 800 then notifies the MS 10 of the services reject (signal 590).

Therefore, the AA in the disclosed authentication system has the SIM card of the MS. Its tasks include processing the service requests of the MS, processing authentication with the MS, processing authentication with the authentication server (e.g. the MSC), controlling the access right of the MS to the Internet, and generating CDR's for the BC.

In the structure shown in FIG. 4, the MS 10 may roam to an external access network. If the MS 10 now needs Internet services, it has to obtain the access right for the AP 35 and the router 45. In the external access network, the access right of the AP 35 and the router 45 is monitored by the ARC 600. Therefore, the MS 10 has to send out a service request to the ARC 600 until it obtains services accept from the ARC 600.

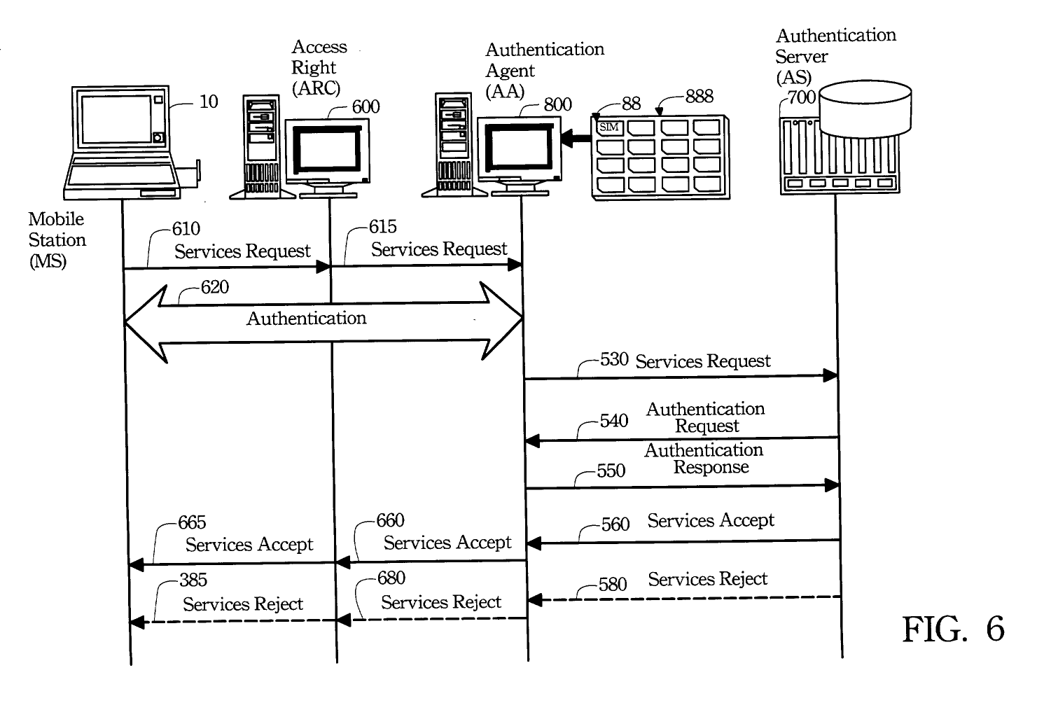

With reference to FIG. 6, the authentication system for a roaming MS comprises four authentication elements: an MS 10, an ARC 600, an AA 800, and an authentication server 700. When the MS 10 roams to the external access network and needs the Internet services, the MS 10 sends out a service request (signal 610) to the ARC 600. The ARC 600 in turn sends out a service request (signal 615) to the AA 800 of the MS 10. The AA 800 starts to process authentication for the MS 10. If the authentication fails, the service request is rejected. If the authentication is successful, the AA 800 processes authentication with the authentication server 700 (signals 530-580 as in FIG. 5). If the authentication is also successful, then the AA 800 notifies the ARC 600 that the service request is accepted (signal 660). The ARC 600 further notifies the MS 10 about services accept (signal 665) and allows the MS 10 to connect to the Internet. On the other hand, if the last authentication fails, the AA 800 notifies the ARC 600 of services reject (signal 680), and the ARC 600 notifies the MS 10 of services reject (signal 685).

Although the invention has been described with reference to specific embodiments, this description is not meant to be construed in a limiting sense. Although the embodiments explicitly refer to the public WLAN, the invention can still be applied to public wired networks. Various modifications of the disclosed embodiments, as well as alternative embodiments, will be apparent to persons skilled in the art. It is, therefore, contemplated that the appended claims will cover all modifications that fall within the true scope of the invention.

Furthermore, the public authentication system of the invention does not install a SIM card on the MS. Instead, a SIM card is installed in the AA so that one does not need to change the design of the user's MS and the manufacturing cost lowers. By processing authentication between the MS and the AA and between the AA and the authentication server using the SIM card of the MS, the invention also achieve the same objective of authentication between the MS and the authentication server.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A public network authentication system, which comprises:
a mobile station (MS);
an authentication server; and
an authentication agent (AA), which has a subscriber identity module (SIM) corresponding to the MS;
wherein the MS processes authentication with the AA and the AA uses the SIM to process authentication with the authentication server.

2. The system of claim 1, further comprising an access network wherein the AA controls the access network to allow connection between the MS and the Internet if the authentication between the MS and the AA is successful.

3. The system of claim 1 further comprising a billing center (BC) and a router, wherein the AA controls the router to generate a charge data record (CDR) to the BC.

4. The system of claim 1, further comprising an external access network containing an access right controller (ARC), wherein when the MS roams to the external access network, the MS first passes authentication with the AA and the AA notifies the ARC to allow the MS to connect to the Internet.

5. A public network authentication method, comprising:
an MS processing authentication with an AA containing an SIM corresponding to the MS using a first protocol; and
the AA using the SIM to process authentication with an authentication server using a second protocol.

6. The method of claim 5, further comprising the AA controlling an access network to allow connection between the MS and the Internet if the authentication between the MS and the AA is successful.

7. The method of claim 5, further comprising the AA controlling a router to generate a CRD to a BC.

8. The method of claim 5 further comprising the AA notifying an ARC to allow the MS to connect to the Internet if the authentication between the MS and the AA is successful when the MS roams to an external access network.

9. An AA for a public network, which has an SIM corresponding to a MS, wherein the AA and the MS use a first protocol to process authentication and the AA uses the SIM to process authentication with an authentication server using a second protocol.

10. The AA of claim 9, also controlling an access network to allow the MS to connect to Internet services.

11. The AA of claim 9, also controlling a router to generate a CDR to a BC.

12. The AA of claim 9, also notifying an ARC of an external access network to allow the Internet connection of the MS when the MS roams to the external access network.
